(19) United States
(12) Patent Application Publication
(10) Pub. No.: US 2025/0077962 A1
(43) Pub. Date: Mar. 6, 2025

(54) ENRICHING ARTIFICIAL INTELLIGENCE MODELS DURING DATA CALL FAILURES USING REAL-TIME INTERNET OF THINGS TOKENS

(71) Applicant: PAYPAL, INC., San Jose, CA (US)

(72) Inventors: Pankaj Sarin, Fremont, CA (US); MD Faisal Khan, Chennai (IN)

(21) Appl. No.: 18/462,337

(22) Filed: Sep. 6, 2023

(51) Int. Cl. G06N 20/00

(52) U.S. Cl. CPC G06N 20/00

(57) ABSTRACT

There are provided systems and methods for enriching AI models during data call failures using real-time IoT tokens. A service provider, such as an electronic transaction processor for digital transactions, may provide computing services to users including those for electronic transaction processing. In order to provide computing services, machine learning engines and neural networks may be used to compute scores ingested by computing services for intelligent decisions, predictions, classifications, and the like. The scores may though have inaccuracies and decay, which may be made worse when data fails to load for particular model or network features. As such, the service provider may utilize a framework to enrich scores through computing their entropy as a function of errors and randomness with their decay as a function of inaccuracies over time. IoT tokens may then be used to enrich and provide further accuracy or validity time based corresponding real-time data.

### TECHNICAL FIELD

The present application generally relates to machine learning (ML) and other artificial intelligence (AI) models, and more particularly to enriching model output scores to provide more accurate model predictions.

### BACKGROUND

Online service providers may provide services to different users, such as individual end users, merchants, companies, and other entities. For example, online transaction processors may provide electronic transaction processing services. When providing these services, the service providers may provide an online platform that may be accessible over a network, which may be used to access and utilize the services provided to different users. During use of these computing services and the processing platforms and services, the service provider may utilize one or more applications, platforms, and/or decision services that implement and utilize ML and other AI (e.g., neural networks (NN), rule-based engines, etc.) models for classifications, predictions, decision-making, and the like during data processing, such as within a production computing environment. For example, an ML model may be used for processing input data for one or more ML features and determining a classification, prediction, decision, or other output. In particular, fraud prediction and risk analysis models may rely on features (e.g., inputs from various downstream systems) in order to compute the fraud likelihood of a particular activity, interaction, or the like, such as a transaction being processed electronically.

There may invariably be a level of entropy associated with the output that lowers the overall accuracy of the computed score, where a lower accuracy fraud model may lead to loss if processing is based on an incorrect score or prediction. Accuracy issues may be caused by several factors, including feature application programming interface (API) data load issues and/or failures from one or more sources, latency in compute time and/or processing, and decay of data (e.g., stale data) being used by the compute function. For example, data call failures, such as a failure of an API to provide or load data, may result in missing data for features of an ML model when generating a score. Further, traditional temporal and time series forecasting is challenging due to issues with variability of temporal data. Conventional temporal and time series forecasting suffers from issues in accuracy due to these challenges and may not adequately consider certain factors and/or temporal data. Therefore, there is a need for more accurate and efficient intelligent systems for classifications and predictions, such as by lifting or enhancing model accuracy of ML and other AI models.

### BRIEF DESCRIPTION OF THE DRAWINGS

FIG. 1 is a block diagram of a networked system suitable for implementing the processes described herein, according to an embodiment;

FIGS. 2A-2C are exemplary diagrams of data processing for enriching scores and outputs of AI models during data call failures using real-time IoT tokens and corresponding data, according to an embodiment;

FIGS. 3A and 3B are exemplary diagrams of a decay function used to enrich and adjust time validity values and accuracies of ML model scores, according to an embodiment;

FIG. 4 is a flowchart of an exemplary process for enriching Ai models during data call failures using real-time IoT tokens, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for enriching AI models during data call failures using real-time IoT tokens. Systems suitable for practicing methods of the present disclosure are also provided. Such systems and methods may be further used for enhanced model accuracy during risk assessment, fraud detection, user behavior prediction, and the like. As such, AI models, such as ML models and NNs may be improved to provide better and more accurate outputs, longer accuracy lifetime, and more efficient model computations.

An online service provider, such as an online platform providing one or more services to users and groups of users, may provide a platform that allows a user to access and/or interact with the service provider, live agents of the service provider, chatbots or interactive voice response (IVR) systems, and/or other audio and audiovisual endpoints through voice and/or video communications, calls, and sessions. The service provider may allow the user to register an account and/or utilize computing services through various platforms, communications, applications, websites, and/or devices, such as to perform electronic transaction processing and/or otherwise utilize an account for transaction, payment, transfer, and other monetary services. However, during use of the computing services, the user, merchant, and/or an agent or other service assisting the user may perform data processing that invokes ML models and engines, or other AI systems, such as for electronic transaction processing. identification of user information, account details, past communications and sessions including corresponding data files and contents, authentication, and the like. Thus, the service provider may provide intelligent computing services to users through these AI systems.

In this regard, the service provider may process input data that corresponds to different features or variables of ML models or other AI processing engines. For example, features may be associated with measurable datum or other piece of data relevant to a computing task or requested output by an ML model. These ML models may be associated with fraud and risk, such as fraud detection models during electronic transaction processing, and therefore process input user, transaction, merchant, and other data to provide a fraud score or assessment of potential fraud. However, when API endpoints and calls are unresponsive, fail, or do not provide proper data, ML model and other AI system accuracy may fall, and fraud scores may be incorrect or of low accuracy that the predictions and decisions are no longer valuable or correct, which can result in additional uses of computing resources to address. As such, in various embodiments, the service provider may provide a system that computes entropy and decay scores associated with model scores and outputs based on the input data, time of processing, missing data and/or unresponsive APIs and/or calls, and the like. The service provider may utilize IoT tokens for real-time data from an IoT infrastructure to then enrich these models and model scores such that an accuracy and/or time-to-live (TTL) values improves for such scores. Thereafter, secure enriched tokens may be output, which may provide improved model accuracy, TTL, and/or trust in the ML models' scores and decisions.

In order to provide computing and intelligent decision-making services, an online service provider (e.g., an online transaction processor, such as PAYPAL®) may provide account services to users of the online service provider, as well as other entities requesting additional services. A user wishing to establish the account may first access the online service provider and request establishment of an account. An account and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including payment card (e.g., credit/debit card) information, bank account information, gift card information, benefits/incentives, and/or financial investments. This information may be used to process transactions for items and/or services. In some embodiments, the account creation may be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services. However, other service providers may also provide the computing services discussed herein, such as telecommunication service providers. Once the account of the user is established with the service provider, the user may utilize the account via one or more computing devices, such as a personal computer, tablet computer, mobile smart phone, or the like. The user may engage in one or more online or virtual interactions that may be associated with electronic transaction processing, images, music, media content and/or streaming, video games, documents, social networking, media data sharing, microblogging, and the like.

The interactions may require or utilize AI decision-making and prediction services, such as fraud assessment and detection that utilize ML models, NNs, and other AI engines for a predictive framework using enriched model scores and tokens. As such, an AI engine make receive input data for processing by extracting data for model or engine features or variables and processing the data to provide an output score, classification, decision, prediction, or the like. For example, a framework and/or infrastructure for the ML models, engines, and enrichment processes may be provided and/or be implemented as pluggable modules or other software and/or hardware components that may be integrated into real-time and/or batch processing systems for executing data calls. The pluggable modules may therefore include operations to integrate with the downstream services to enrich ML model scores and classifications using IoT tokens and the like. An online transaction processor or other service provider may execute operations, applications, decision services, and the like that may be used to process transactions between two or more users or entities, as well as provide other computing services and automated decision-making.

In order to do so, a service provider may utilize NNs including deep NN (DNN), LSTM, GRU, or other RNN architectures, ML models, and/or other artificial intelligence (AI) systems. Initially, the service provider may train a DNN or other ML model for a predictive output or classification. In order to train the DNN or other ML models, training data for the models may be collected and/or accessed. The training data may correspond to a set or collection of features from some input data records, which may be associated with users, accounts, activities (e.g., past transactions, frauds, etc.), events, external computing services, entities, and the like. In this regard, a feature may correspond to data that may be used to output a decision by a particular node, which may lead to further nodes and/or output decisions by the DNN or another ML model. Training may be done by creating mathematical relationships based on the NN or other ML algorithm to generate predictions, classifications, and other outputs, such as those associated with fraud detection and scores, risk, and the like. The NN or ML model trainer may perform feature extraction to extract features and/or attributes used to train the model from the training data. For example, training data features may correspond to those data features which allow for value determinations and/or outputs by nodes of a model, which may be used in the final predictive output, score, or classification.

Once trained, DNNs and other ML models may be deployed in production environments for intelligent decision-making, classifications, predictions, and other outputs. Data for features may be received and/or collected from various APIs and API endpoints. However, an API may fail and/or an API call may be unresponsive, thereby causing data to fail to load for one or more features. This may be due to source failure, API call errors or failure, latency, data decay, and the like. When such data fails to load or is stale and inaccurate, outputs of the ML models and other AI systems may be inaccurate. As such, the service provider may enrich such models and corresponding output scores using IoT tokens and corresponding real-time data based on entropy and decay score calculations. Thus, in response to detecting an API failure or other data load failure, a model enrichment framework and system may be invoked to improve model accuracy and TTL of output scores.

For example, the initial fraud or other ML model may have a compute with a failure, which relies on less than all of the features. An entropy score calculation may then be performed by the service provider's model enrichment framework and system. The entropy score may seek to identify and assess a randomness or errors in the initial computed function of the model score, such as the inaccuracy introduced by the API or other data load failure. An entropy function may be executed by the model enrichment framework, which may first retry the failed API and/or call that results in the lack of data, or otherwise attempt to retrieve and access the data that failed to load. If successful, the model may be rerun with the data that may result in a difference in scores, which may be used to assess accuracy. However, if the data further fails to load, the entropy function may access and retrieve a past model score for the user and/or user's ID via a cache or offline data snapshot when fraud was last measured for the user. The entropy function may measure the entropy score based on previous activities and differences in activities of the user and system including the behavior of the user from the previous score and system components used with the previous score. For example, the user behavior may include an online shopping history, frequented location, ATM and other payment or merchant terminals and devices used, past merchants, and the like. System components used may include devices and operating systems, Internet service providers (ISPs), geo-location data, hypertext transfer protocol (HTTP) headers and data, and the like.

The model enrichment framework may further compute a decay score of the corresponding data and output score. The decay score may correspond to a measurement or indication of the viability and “freshness” of the score and data, which may correspond to the accuracy of the model score as time passes or increases since initial compute time. In this regard, the decay score may be calculated using input variables and data for the feature's data pulled in using the entropy function and for which the entropy score was calculated, such as those features and corresponding data associated with the dataset, transaction history, financial instrument, user profile and the like. The data decay function may analyze a time decay weighted average for the data, a dynamic decay update of the data, a user channel used for data communication, user device and operating system factors, network latency, the computed entropy score, and/or an overall impact to fraud model accuracy when considering decay caused by failure of data loading for model score output of a particular feature on the model score. The decay score may also be calculated using this data at the overall model level when utilizing all available factors, including IoT tokens.

Thereafter, an IoT system and infrastructure may be used to determine and retrieve IoT tokens for real-time data tracked, monitored, and/or captured by the IoT infrastructure and corresponding devices, servers, and/or sensors. For example, the IoT infrastructure may correspond to a smart city with data monitoring sensors and components for various users and device. The IoT tokens may be used to track and monitor, for particular interactions, incremental metadata for events and activities associated with the IoT tokens having corresponding real-time data for users and/or devices that includes a real or IP address, a location, a real-time captured images, a device identifier, a time of day, and the like. These may be separated into particular entities (e.g., location is a first entity, user image is another entity, etc.) to establish scores to the particular missing data from the failed call or load.

A final reconciled scoring manager may the combine and process all scores to provide an enrichment factor or score to the last model score having the missing data. The final compute score may then have a computed higher accuracy using the last model score with an affected decay or TTL of the new enriched model score based on data decay. An enriched token, such as a secure cryptogram, may be generated for the enriched model score and provided or shared for actionable processing of user requests and other data processing requests that come in from user activities, such as electronic transaction processing. In this manner, a service provider may obtain enhanced model accuracy during failure conditions of data calls and other data loading events. This may improve decision-making and accuracy of decisions and intelligent outputs by models, while also reducing the time taken during model predictions by allowing model computation when APIs and/or calls are unresponsive. Thus, the model enrichment framework may improve the technical field and operations of AI systems.

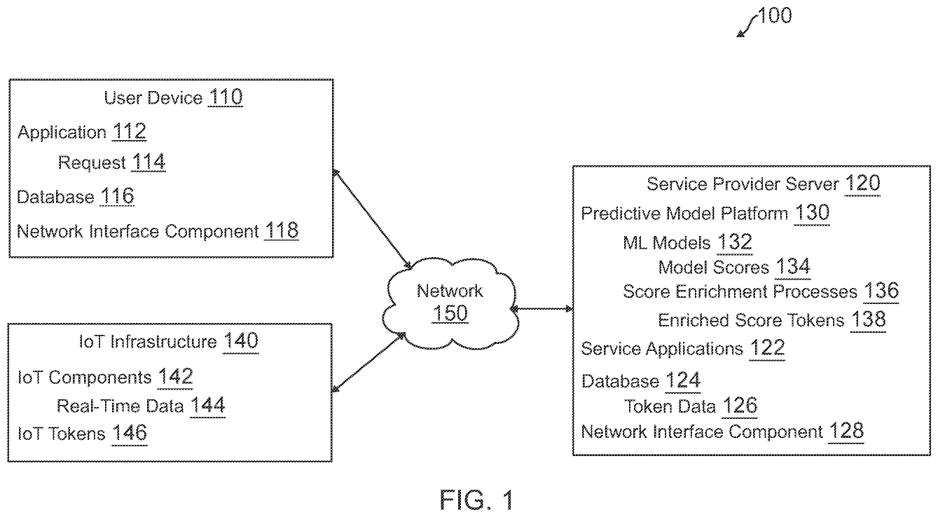

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a user device 110, a service provider server 120, and IoT infrastructure 140 in communication over a network 150. User device 110 may be utilized by users or other entities to interact with service provider server 120 over network 150, where service provider server 120 may provide various computing services, data, operations, and other functions over network 150 that may include use of data from IoT infrastructure 140. In this regard, user device 110 may perform activities with service provider server 120 for account establishment and/or usage, electronic transaction processing, and/or other computing services. Service provider server 120 may provide intelligent computing services to users through ML models, NNs, and/or other AI systems to user device 110. In this regard, to enrich outputs and scores when providing services to user device 110, IoT infrastructure 140 may be used by service provider server 120 to obtain IoT tokens for real-time data that may change an entropy and decay weight, score, or other factor applied to the output score's accuracy, TTL, and other parameter.

User device 110, service provider server 120, and IoT infrastructure 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented as a computing and/or communication device that may utilize appropriate hardware and software configured for wired and/or wireless communication with service provider server 120. For example, in one embodiment, user device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one user computing device is shown, a plurality of user computing device may function similarly.

User device 110 of FIG. 1 contain an application 112, a database 116, and a network interface component 118. Application 112 may correspond to executable processes, procedures, and/or applications with associated hardware. In other embodiments, user device 110 may include additional or different modules having specialized hardware and/or software as required.

Application 112 may include one or more processes to execute software modules and associated components of user device 110 to provide features, services, and other operations to a user from service provider server 120 over network 150, which may include account, electronic transaction processing, and/or other computing services and features provided by service provider server 120. In this regard, application 112 may correspond to specialized software utilized by users of user device 110 that may be used to access a website or application (e.g., mobile application, rich Internet application, or resident software application) that may display one or more user interfaces that allow for interaction with service provider server 120, for example, to access an account, process transactions, and/or otherwise utilize computing services. In various embodiments, application 112 may correspond to one or more general browser applications configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. However, in other embodiments, application 112 may correspond to a dedicated application of service provider server 120 or other entity (e.g., a merchant) for transaction processing via service provider server 120. Thus, application 112 may be used to transmit or provide a request 114 to service provider server 120 for data processing, which may utilize IoT infrastructure 140 during data processing. For example, request 114 may include a request for a data processing event that uses data from IoT tokens generated by components, devices, and sensors on IoT infrastructure 140.

Application 112 may utilize, process, and/or provide account information, user financial information, and/or transaction histories for electronic transaction processing, including processing transactions using financial instrument or payment card data. Application 112 and/or another device application may be used to request data processing of request 114 using data from IoT infrastructure 140 that may be used to enrich model scores and the like from ML models, DNNs, and the like that provide classifications, predictions, decision-making, and other outputs used by computing services of service provider server 120. Prior data requests and other data processing events may be used to train ML and DNN models. The training data may include one or more data records, which may be stored and/or persisted in a database and/or data tables accessible by service provider server 120. Thereafter, the DNN or ML model(s) may be deployed in production computing environments, where service provider server 120 may use such models and networks for intelligent outputs and with computing services. However, during use of models, input data for features may be unavailable as APIs fail or unresponsive, and data calls may not retrieve or access data for particular features of the DNN or ML model. As such, service provider server 120 may utilize IoT infrastructure 140 to enrich model scores using IoT data and corresponding ones of IoT tokens 146, which may enhance model accuracy, reliability, TTL, and/or trust based on the available data.

Additionally, application 112 may be used to view the results of processing request 114, such as outputs, results, and the like from use of computing services of service provider server 120. In this regard, application 112 may be used for one or more data processing tasks, such as electronic transaction processing. During processing of an electronic transaction, application 112 may be utilized to enter, view, and/or process items the user wishes to purchase in a transaction, as well as perform peer-to-peer payments and transfers. In this regard, application 112 may provide transaction processing through a user interface enabling the user to enter and/or view the items that users associated with user device 110 wish to purchase and submit request 114 for purchase of the item(s). Thus, application 112 may also be used by a user to provide payments and transfers to another user or merchant, which may include transmitting request 114 to service provider server 120. Processing of request 114 may utilize one or more DNNs and/or ML models during processing by computing services (e.g., risk, fraud detection, credit or underwriting, etc.), which may have resulting scores enriched by data and IoT tokens 146 from IoT infrastructure 140.

For example, accounts and electronic transaction processing may include and/or utilize user financial information, such as credit card data, bank account data, or other funding source data, as a payment instrument when providing payment information to service provider server 120 for the transaction. Additionally, application 112 may utilize a digital wallet associated with an account with a payment provider as the payment instrument, for example, through accessing a digital wallet or account of a user through entry of authentication credentials and/or by providing a data token that allows for processing using the account. Application 112 may also be used to receive a receipt or other information based on transaction processing. Further, additional services may be provided via application 112, including social networking, media posting or sharing, microblogging, data browsing and searching, online shopping, and other services available through service provider server 120.

User device 110 may further include database 116 stored on a transitory and/or non-transitory memory of user device 110, which may store various applications and data and be utilized during execution of various modules of user device 110. Database 116 may include, for example, identifiers such as operating system registry entries, cookies associated with application 112 and/or other applications, identifiers associated with hardware of user device 110, or other appropriate identifiers, such as identifiers used for payment/user/device authentication or identification, which may be communicated as identifying a user and/or user device 110 to service provider server 120. Moreover, database 116 may store data used for generating and/or transmitting request 114, including digital tokens for digital wallets, accounts, and/or financial instruments and the like.

User device 110 includes at least one network interface component 118 adapted to communicate with service provider server 120 and/or another device or server. In various embodiments, network interface component 118 may each include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services including account and electronic transaction processing services. In this regard, service provider server 120 includes one or more processing applications which may be configured to interact with user device 110 to provide computing and customer services using one or more ML, NN, or other AI models and engines. In various embodiments, use of the intelligent computing services may utilize data from IoT infrastructure with correspond decay and entropy of model scores to enrich such scores and provide more accurate model outputs. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a predictive model platform 130, service applications 122, a database 124, and a network interface component 128. Predictive model platform 130 and service applications 122 may correspond to executable processes, procedures, and/or applications with associated hardware. In other embodiments, service provider server 120 may include additional or different modules having specialized hardware and/or software as required.

Predictive model platform 130 may correspond to one or more processes to execute modules and associated specialized hardware of service provider server 120 to provide intelligent machine outputs used with computing services provided to users including use of ML models 132 to generate model scores 134 that may be consumed and utilized during execution and use of service applications 122. Further, predictive model platform 130 includes score enrichment processes 136 to generate enriched score tokens 138 to provide further and enhanced accuracy of model scores 134 from ML models 132 based on entropy and decay of model scores 134 during and after computation with information from IoT infrastructure 140. In this regard, predictive model platform 130 may correspond to specialized hardware and/or software used by a user associated with user device 110 in conjunction with service applications 122 for intelligent computing services. Predictive model platform 130 may receive or detect events that request data processing and intelligent outputs using ML models 132, such as model scores 134 that may be used during computing service provision. The events may be associated with data processing requests, actions, activities, or the like that occur for a user, account, entity, device, or the like. In this regard, predictive model platform 130 may utilize ML and/or DNN models, such as ML models 132 having trained layers based on training data and selected ML features or variables, to determine and output model scores 134. Using model scores 134, determination of entropy and/or decay in model scores 134, such as based on API call failures or other lack of data during computation of model scores 134, which may be eligible for enrichment using score enrichment processes 136. IoT tokens 146 may be received and/or requested for real-time data 144 from IoT infrastructure 140, which may then be used by score enrichment processes 136 for enrichment of model scores 134. IoT tokens 146, as well as real-time data 144, may be received in response to API requests or other API calls to IoT infrastructure 140 and have corresponding API responses from IoT infrastructure 140. The resulting enriched score tokens 138 may include enrichment to model accuracy, TTL of model scores 134, and the like, which may be used for further accuracy, reliability, and/or validity length based on the availability of real-time data 144 for corresponding data that failed to load or be received during computation of model scores 134 by ML models 132.

In this regard, ML models 132 may initially be trained using training data determined and/or extracted from data tables and/or data records for corresponding features or variables selected for training of ML models 132 and decision-making during execution of ML models 132. For example, ML features or variables may correspond to individual pieces, properties, characteristics, or other inputs for an ML model and may be used to cause an output by that ML model once the ML model has been trained using data for those features from training data. ML models 132, once trained, may be used for computation and calculation of model scores 134 based on ML layers that are trained and optimized. ML models 132 may be trained to provide a predictive output, such as a score, likelihood, probability, or decision, associated with a particular prediction, classification, or categorization of model scores 134.

For example, ML models 132 may include DNN, ML, or other AI models trained using training data having data records that have columns or other data representations and stored data values (e.g., in rows for the data tables having feature columns) for the features. When building ML models 132, training data may be used to generate one or more classifiers and provide recommendations, predictions, or other outputs for model scores 134 based on those classifications and an ML or NN model algorithm and architecture. Such determination of model scores 134 may be used with service applications 122 during the provision of computing services, such as risk, fraud detection, authentication, credit or underwriting, marketing, or the like. The data calls to particular APIs and corresponding API endpoints may incur issues that fail to load data or otherwise fail and be unresponsive, thereby not loading all the data required by ML models 132 and leading to one or more of model scores 134 have sub-optimal processing for proper scoring and output.

However, decisions and predictions may still be made and valuable for service applications 122, and therefore model scores 134 may still be useful even when generated without all feature data for the corresponding one of ML models 132. The amount of inaccuracy or changes to TTL of model scores 134 may be assessed using an entropy and decay, which may be applied to model scores 134 to adjust accuracy and the like. Further, IoT infrastructure 140 may be availed to provide IoT tokens 146, which may increase accuracy, TTL, or other parameters indicating the value or reliability of model scores 134. Thus, by utilizing IoT tokens 146, score enrichment processes 136 may generate enriched score tokens 138 to provide additional accuracy and other benefits to model scores 134.

The algorithm and architecture for training ML models 132 may correspond to DNNs, ML decision trees and/or clustering, and other types of ML architectures. The training data may be used to determine features, such as through feature extraction and feature selection using the input training data. For example, DNN models for ML models 132 may include one or more trained layers, including an input layer, a hidden layer, and an output layer having one or more nodes, however, different layers may also be utilized. As many hidden layers as necessary or appropriate may be utilized and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used to train ML models 132, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models 132 that attempt to classify and/or categorize the input feature data and/or data records. Thus, when ML models 132 are used to perform a predictive analysis and output, the input data may provide a corresponding output for model scores 134 based on the classifications trained for ML models 132.

Layers of ML models 132 may be trained by using training data associated with data records and a feature extraction of training features. By providing training data to train ML models 132, the nodes in the hidden layer may be trained (adjusted) such that an optimal output (e.g., a classification) is produced in the output layer based on the training data. By continuously providing different sets of training data and penalizing ML models 132 when the output of ML models 132 is incorrect, ML models 132 (and specifically, the representations of the nodes in the hidden layer) may be trained (adjusted) to improve its performance in data classifications and predictions, such as outputs of model scores 134. Adjusting ML models 132 may include adjusting the weights associated with each node in the hidden layer.

Score enrichment processes 136 may be provided to introduce, add, or modify model scores 134 by effects, loss on classification or outputs, and the like caused by executing ML models 132 without all of the feature data for a feature set of the corresponding model(s). For example, one of ML models 132 may have a corresponding feature set where an API failure results in a lack of data or output of the data for a particular feature. As such, the resulting computing score of model scores 134 relies on data for less than all features, where the missing feature may have no data or a substituted data to account for the API failure. To adjust, score enrichment process may calculate an entropy score as an assessment of the randomness or errors in the initial computed function and score caused by the API failure (e.g., unresponsive or no data API/call or failure to load data from such API/call). However, with the entropy calculation, a model score and/or feature data for a previous model score may be fetched for the given customer or event identifier, such as one for a last score calculation. A decay score may be calculated as a time-based decay associated with the feature pulled in with the entropy calculation. With the entropy and decay scores, one or more of IoT tokens 146 may be availed to establish correlations with such scores and available real-time data. Score enrichment processes 136 may process the data together using a formula to calculate enriched score tokens 138, which may then be consumed by service applications 122 during computing service provision.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may be used by users associated with user device 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by service provider server 120.

In this regard, enriched score tokens 138 may be generated, which may be processed with corresponding real-time data 144 as token data 126 for decision-making, predictions, classifications, and the like during data processing by service applications 122. Thus, enriched score tokens 138may include data used for authentications, risk analysis, fraud detection, and the like for account access and/or account use. Computing services of service applications 122 may also or instead correspond to messaging, social networking, media posting or sharing, microblogging, data browsing and searching, online shopping, and other services available through service provider server 120. Thus, enriched score tokens 138 may be used for other computing services based on model scores 134 for use with users, customers, and other entities.

Service applications 122 may also be desired in particular embodiments to provide features to service provider server 120. For example, service applications 122 may include security applications for implementing server-side security features, programmatic client applications for interfacing with appropriate application programming interfaces (APIs) over network 150, or other types of applications. Service applications 122 may contain software programs, executable by a processor, including a graphical user interface (GUI), configured to provide an interface to the user when accessing service provider server 120 via one or more of user device 110, where the user or other users may interact with the GUI to view and communicate information more easily. In various embodiments, service applications 122 may include additional connection and/or communication applications, which may be utilized to communicate information to over network 150.

Service provider server 120 further includes database 124. Database 124 may store various identifiers associated with user device 110. Database 124 may also store account data, including payment instruments and authentication credentials, as well as transaction processing histories and data for processed transactions. Database 124 may store financial information or other data generated and stored by predictive model platform 130. Database 124 may also include data and computing code, or necessary components for ML models 132. Database 124 may also include training data, input, and/or feature data having data records, as well as data for model scores 134 and enriched score tokens 138 that may be processed during provision of computing services by service applications 122.

In various embodiments, service provider server 120 includes at least one network interface component 128 adapted to communicate with user device 110, IoT infrastructure 140, and/or other devices or server over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

IoT infrastructure 140 may correspond to a network of devices, sensors, applications, and other components that are connected within or in association with one or more real-world locations, such as a city, county, region, or the like. In this regard, IoT infrastructure 140 includes IoT components 142 corresponding to one or more websites, applications, devices, sensors, servers and server systems, cloud computing platforms and storages, and other resources that may detect and collect real-time data 144 and other information associated with the location(s) and provide IoT tokens 146 for real-time data 144 to service provider server 120 in response to executed data calls and requests (e.g., API calls to APIs of IoT infrastructure 140). IoT infrastructure 140 may be provided by a location, city, or the like for detecting real-time data 144, which may utilize IoT components 142 for data collection and processing purposes. In some embodiments, IoT infrastructure 140 may be hosted, provided by, and/or utilized by a merchant, seller, or the like to advertise, market, sell, and/or provide items or services for sale, as well as provide checkout and payment. As such, IoT components 142 may be distributed throughout and/or connected with the location for data detection purposes.

As such, real-time data 144 may correspond to images, video, audio, location-based data, communications, device connections and/or pings to local devices or servers, check-ins or check-outs, processing of transactions, telecommunications, vehicle movements or use, appliance and other device use, and the like. Real-time data 144 may therefore correspond to IP addresses, geo-locations, real-time/last known pictures of the subject, device identifiers, time of the day for events, etc., as well as metadata for IoT infrastructure 140. Real-time data 144 may be broken down into discrete entities to establish correlations with the scores and data from ML models 132 of service provider server 120. Further, one or more of IoT infrastructure 140 may correspond to token service providers (TSPs), such as those that may provide and/or utilize network tokens and network token cryptograms for tokenizing real-time data 144 for provision of IoT tokens 146 to service provider server 120. As such, IoT tokens 146 may correspond to secure tokens for real-time data 144 that may be used to retrieve, determine, and validate real-time data 144 for use in enriching model scores 134 of ML models 132. In some embodiments, the processes, APIs and/or API integrations for data requesting and retrieval by service provider server may be based on one or more operations, software development kits (SDKs), API standards or guidelines, and the like that may be implemented in the corresponding computing service of service provider server 120 for requesting and receiving IoT tokens 146, as well as corresponding data from real-time data 144 detected by IoT components 142.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

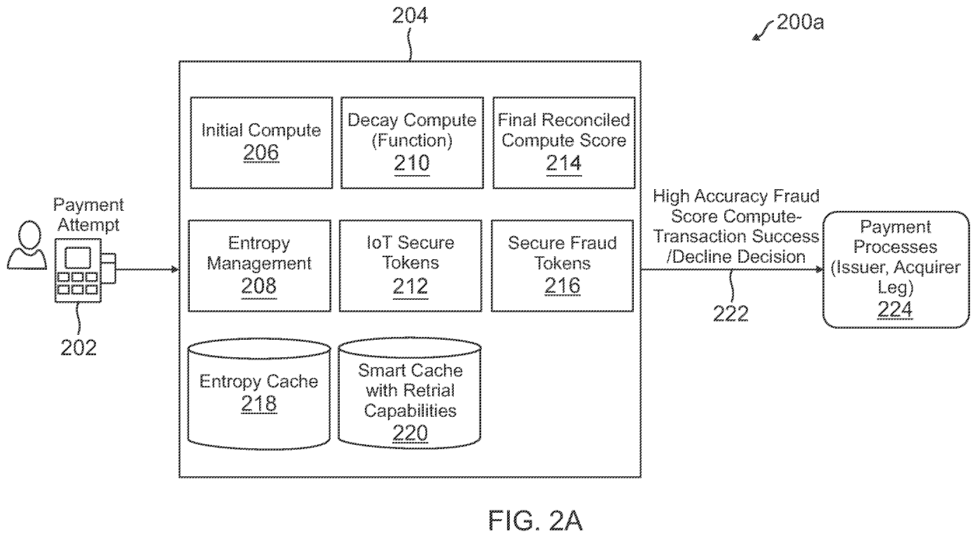

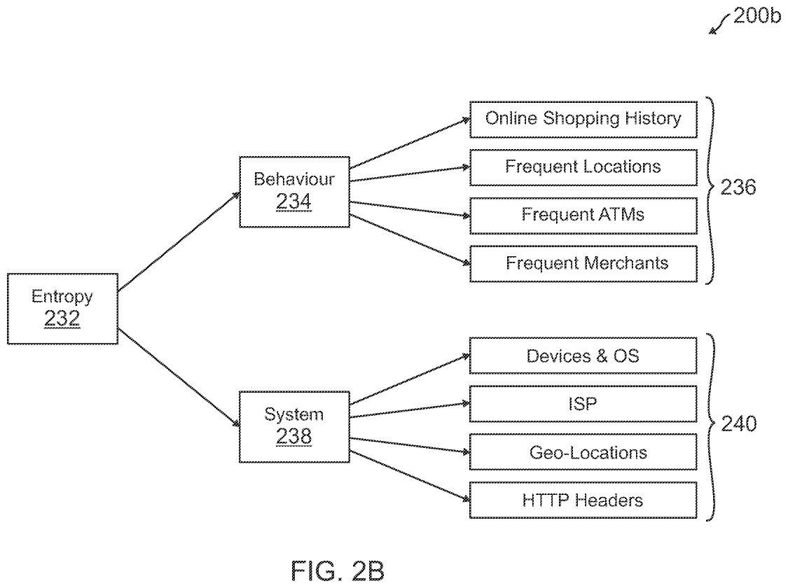

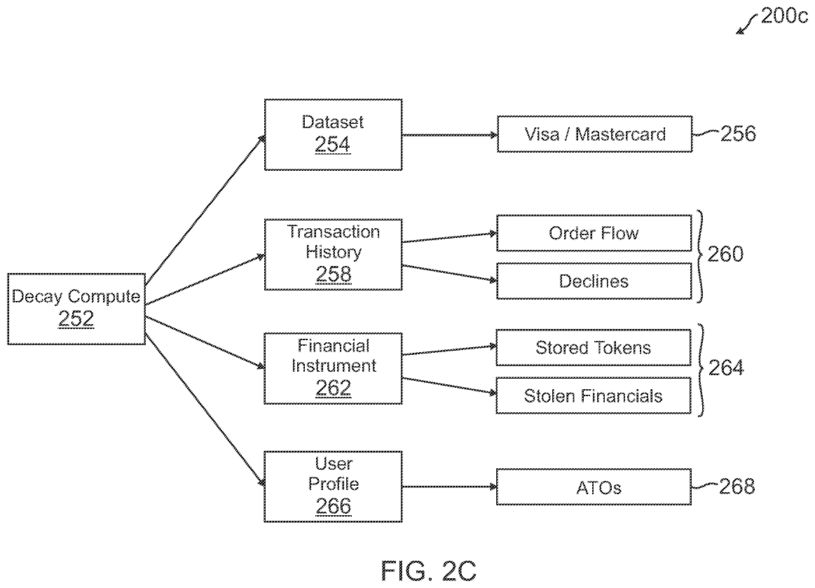

FIGS. 2A-2C are exemplary diagrams of data processing for enriching scores and outputs of AI models during data call failures using real-time IoT tokens and corresponding data, according to an embodiment. Diagram 200a includes a system architecture that provides a fraud score or other model compute and output for intelligent computing services when processing a payment attempt 202. In this regard, an ML compute system 204 processing payment attempt 202 may correspond to one or more of ML models 132 when executed by predictive model platform 130 of service provider server 120, discussed in reference to system 100 of FIG. 1.

In diagram 200a, a real-time computing environment, according to one embodiment, is shown that is utilized to process payment attempt 202 and/or other requests and uses of computing services, such as one of electronic transaction processing using an online transaction processor or the like. Prediction of risk, fraud, or the like, as well as authentication and/or authorization, may be required for transaction processing, where ML compute system 204 may provide such automated and machine intelligence through ML models. In this regard, ML compute system 204 may include components needed for ML model computes and output scores, which may be enriched to provide further accuracy and confidence. This may be of particular importance with ML computations lacking data for one or more features.

In this regard, ML compute system 204 includes an initial compute 206 resulting from execution of an ML model using available feature data, which may be missing data for one or more features for the ML model. The missing data may therefore cause inaccuracies and/or quick decay or low TTL of the resulting output. As such, an entropy management 208 may add an entropy score to initial compute 206 to account for inaccuracies, errors, and/or randomness introduced by missing data when running the ML model on the input data. Entropy management 208 may further access a previous ML score or compute, which may allow for a previous compute and/or data to be used to supplement the missing data. Entropy management 208 may use an entropy cache 218 to access past model computes, as well as a smart cache with retrial capabilities 220 for past data and/or computes. A decay function 210 further may be added to determine changes to TTL and the like caused by the missing data and/or based on introducing the previous compute and/or data.

To increase accuracy and/or TTL of initial compute 206, an IoT secure token 212 may be availed from an IoT infrastructure and/or system. IoT secure token 212 may correspond to real-time data from the IoT infrastructure and components, which may assist in improving the confidence in initial compute 206, as well as accuracy and/or TTL based on real-world detected data. Using the data, a final reconciled compute score 214 may be determined, which may correspond to the enriched model score, compute, or other output. Final reconciled compute score 214 may be tokenized as secure fraud token 216, which may be stored with smart cache with retrial capabilities 220 and made available to computing services for use. Thus, when required for processing, secure fraud tokens 216 may be accessed. For example, with payment attempt 202, a high accuracy fraud score compute 222 may be output to payment processes 224 for payment authorization or denial.

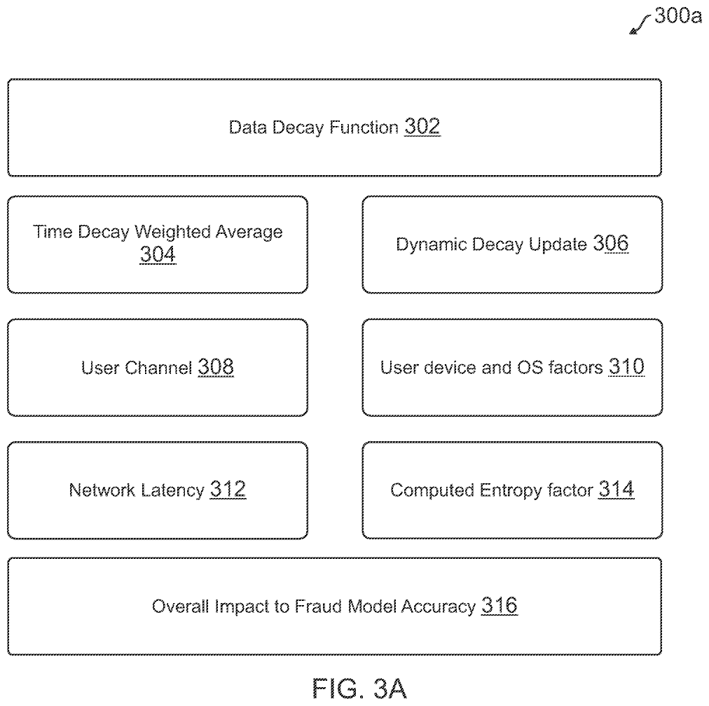

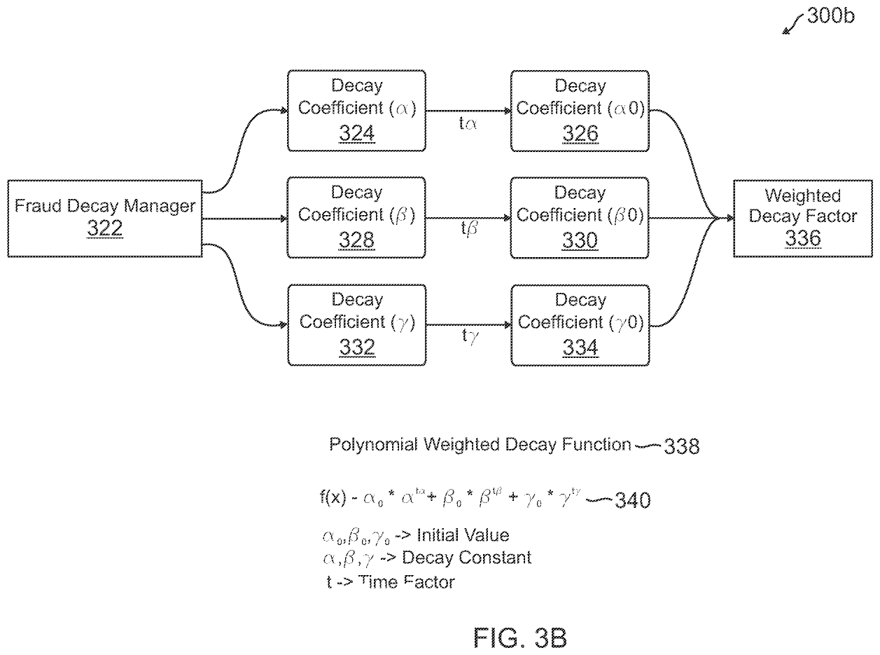

Referring to FIG. 3B, diagram 200b shows entropy that may be calculated using the represented parameters and data for entropy with an entropy formula or calculation, according to one embodiment. In this regard, diagram 300b shows an entropy 232 that may be calculated by entropy management 208 from diagram 200a based on the components listed in diagram 200b. As such, entropy 232 may be used when enriching model scores and outputs, such as when generated final reconciled compute score 214.

For entropy 232, data for a behavior 234 associated with behavior parameters 236 may be used with data for a system 238 including system parameters 240. For example, behavior parameters 236 may include an online shopping history, frequent locations, frequent ATMs, and/or frequent merchants, although such parameters are merely representative and additional, fewer, or other parameters may also be used. Behavior parameters 236 may correspond to expected behaviors and therefore may be used in place of missing data and/or to determine deviations from expected behavior and thus errors that may be introduced when data is missing. For system 238, system parameters 240 may include devices and operation system (OS), Internet service provider (ISP), geo-locations, and/or hypertext transfer protocol (HTTP) headers (e.g., data from requests by a client), although such parameters are merely representative and additional, fewer, or other parameters may also be used. As such, system parameters 240 may indicate expected data for a system making a request, such as payment attempt 202, which may be used to determine both expected system data and/or errors from missing data. Additionally, past known data for behavior parameters 236 and system parameters 240 may be used to supplement missing data with the last known record.

Referring now to FIG. 2C, diagram 200c shows decay that that may be calculated using the represented parameters and data for decay with a decay formula or calculation, according to one embodiment. In this regard, diagram 300c shows a decay compute 252 that may be calculated by decay function 210 from diagram 200a based on the components listed in diagram 200c. As such, decay compute 252 may be used when enriching model scores and outputs, such as when generating final reconciled compute score 214.

In diagram 300c, decay compute 252 may be generated and determined as a function of a dataset 254, a transaction history 258, a financial instrument 262, and a user profile 266. In this regard, dataset 254 may correspond to the data associated with the request being processing using the intelligent ML model, such as user and/or request data when processing payment attempt 202. As such, dataset parameters 256 may include Visa/Mastercard data, for payment data associated with the request (e.g., payment attempt 202), although other card and/or payment data for the user may also be used. Transaction history 258 may include history parameters 260 for past transactions, including an order flow of transaction processing orders and flows for processing transactions and declines of specific transactions (including decline reason). Financial instrument 262 may be associated with instrument parameters 264 when processing the provided financial instrument, such as stored tokens and stolen financials. Additionally for determining decay compute 252, profile parameters 268 for a user profile 266 may be used, including any account takeovers (ATOs) for the corresponding account of the user.

FIGS. 3A and 3B are exemplary diagrams 300a and 300b of a decay function used to enrich and adjust time validity values and accuracies of ML model scores, according to an embodiment. For example, diagram 300a shows a data decay function 302 as a function of the listed parameters in a similar manner to diagram 200c of FIG. 2C. These parameters are then shown as processed using a fraud decay manager 322 in diagram 300b. As such, data decay function 302 in diagram 300a may be computed using fraud decay manager 322 in diagram 300b by predictive model platform 130 using score enrichment processes 136 in system 100 of FIG. 1.

For example, entropy may be associated with model scores, especially where such scores may be computed when missing particular data for one or more features. Further, latency in compute and the like may also introduce errors and therefore inaccuracies. However, stale or old data may also introduce errors, randomness, and inaccuracies that lower reliability and confidence in model scores through decay, which may be computed using data decay function 302 by fraud decay manager 322. As such, when missing data is supplemental with past model scores and/or data, as well as when IoT tokens for real-world data is used, measuring decay as a score that may affect accuracy and/or TTL may be used to enrich scores and provide further accuracy and confidence.

Data decay function 302 may utilize a time decay weighted average 304 to apply a time-based decay to the data used during model score computation and determination. Additionally, a dynamic decay function 306 may be used where a 5% decay per unit of time (e.g., second) may be introduced but changed to an additional decay when missing data (e.g., 10% per unit of time with a failure of an API and/or data load in the dataset). A user channel 308 may introduce decay and add to computation of data decay function 302, such as a web, mobile, mobile-web, chat, phone, SMS, etc., channel each having a specific decay based on the data and/or data reliability. User device and OS factors 310 may also introduce decay and be considered, such as where older devices and/or OS may be more vulnerable, as well as the type of device and/or OS. A network latency 312 may introduce decay based on the latency of receiving data and any potential slowdown or data transmission. With data decay function 302, the computed entropy factor 314 may also be added, where an overall impact to fraud model accuracy 316 may the be computed as a function of the aforementioned components.

Referring to FIG. 3B, in diagram 300b, fraud decay manager 322 may compute a weighted decay factor 336 to apply to a model score during enrichment based on decay of corresponding data when computing the model score. As such, fraud decay manager 322 may be based on a decay coefficient 324 applied to an initial decay 326, a decay coefficient 328 applied to an initial decay 330, and a decay coefficient 332 applied to an initial decay 334, which may be combined into weighted decay factor 336. Polynomial weighted decay function 338 shows the function for utilizing decay coefficients 324, 328, and 332 with initial decays 326, 330, and 334 in decay equation 340. There, initial values for decay may be computed with decay constants and a time factor to provide an output for weighted decay factor 336.

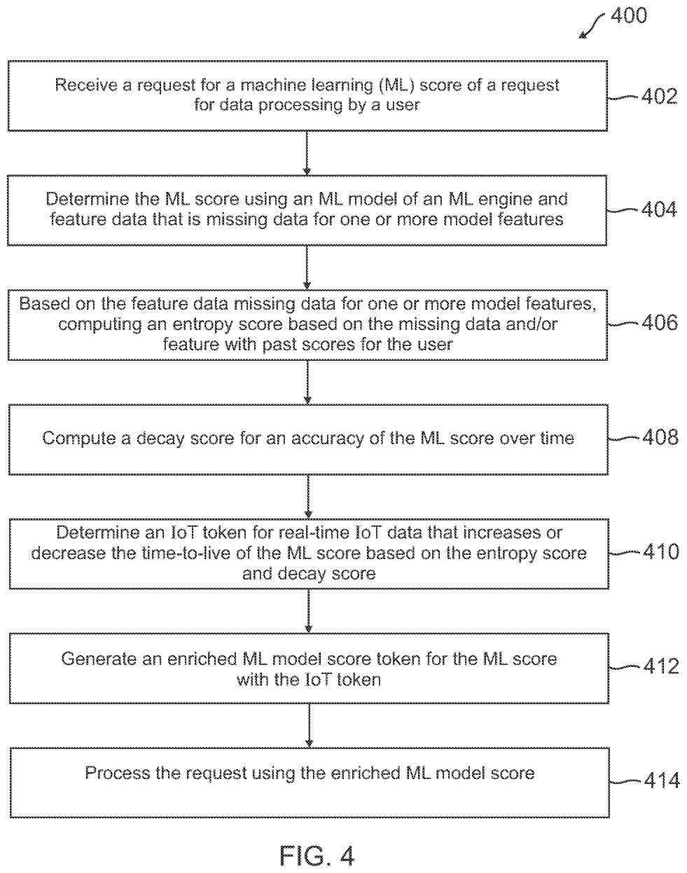

FIG. 4 is a flowchart 400 of an exemplary process for enriching AI models during data call failures using real-time IoT tokens, according to an embodiment. Note that one or more steps, processes, and methods described herein of flowchart 400 may be omitted, performed in a different sequence, or combined as desired or appropriate.

At step 402 of flowchart 400, a request for an ML score during computing service use by a user is received. The request may be received from the user directly, such as a risk or fraud score or the like, or the request may be received from a system, engine, and/or application that may utilize the score during provision of computing services, such as an electronic transaction processing application that may use the risk or fraud score in determining whether to proceed with transaction processing. At step 404, the ML score is determined using an ML model of an ML engine and feature data, where the feature data has missing data for one or more model features. For example, the ML model for computation of the score may require data for a feature set, where one or more of the features in the feature set may have data that is unavailable, does not load, or fails to be retrieved. For example, an API may fail or be unresponsive to an API call based on failures, communication or network issues, and the like. As such, the score may be determined but may be missing data that may cause issues in accuracy and/or TTL of the score.

At step 406, based on the feature data missing for one or more model features and past scores for the user, an entropy score is computed. For example, the entropy score may correspond to a measure or indicator in the randomness, introduced inaccuracy, and/or errors in the initial computation of the model score. This may be based on the model score having missing data for one or more features, and therefore, the entropy score may be based on past similar API and/or data load failures during model score calculation and/or measured inaccuracies in model score calculation resulting from missing data. With calculation of the entropy score, the system may fetch a past model score for comparison and/or feature data for the past model score, which may be used in place of the missing feature to compute a model score and a difference in accuracy or the entropy caused by the missing data during use of the ML model for score computation.

At step 408, a decay score for a decay in the accuracy of the ML score over time is computed. The decay score may correspond to a TTL, which indicates a length of time that the model score is considered to be valid and/or accurate, which allows use of the model score over the TTL before it is considered inaccurate or invalidated pending further computation of a new model score. As such, the decay score may indicate how quickly or how much further the TTL has decayed based on the missing data and/or the past model scores and feature data from the past model scores (e.g., where the older past model scores and/or feature data may be stale and less accurate). As such, the decay score may be associated with the feature pulled in and the model at an overall level based on the length of time the score is considered to be accurate, “live,” or useful for intelligent outputs and computing service use.

At step 410, an IoT token for real-time IoT data that changes the TTL of the ML score is determined. An IT infrastructure and/or framework may be associated with a real-world physical location where sensors, devices, servers, and other components may be established to collect, detect, and/or monitor real-world data, which may be used to supplement or replace missing data for the ML model during determination of the model score. For example, where the ML model is associated with fraud, the IoT sensors and system may detect the user at a real-world location to associate the user with the location, a transaction, and/or whether the user is behaving as predicted or in line with the models score. For the real-world data, IoT tokens may be generated, which may be stored and/or accessible. As such, an IoT token for such data may be availed and used to increase or decrease the TTL and/or accuracy of the ML model based on whether the score aligns with such data.

At step 412, an enriched ML model score token is generated for the ML score with the IoT token. The enriched ML model score token may correspond to the ML model score that has been enriched or adjusted by the entropy score, the decay score, and real-time data for the IoT token, which may further be associated with the missing data for the corresponding model feature. As such, the additional scores and data added and combined in the enriched model score from the decay and entropy scores with the real-time data and/or IoT token causes the model score to have further parameters allowing for it to be validated and accurate. The enriched model score may be tokenized and consumed by other processors and applications. As such, the enriched model score token allows for further accuracy. At step 414, the request is processed using the enriched ML model score. With the added accuracy from enrichment and the additional data applied to the initially calculated model score, a corresponding computing system and/or application may utilize the score to provide more accuracy and/or reliability during computing service provision and use. As such, the request from the user may be processed with higher confidence that the model score is accurate and useful for decision-making, predicting, classifying, and the like.

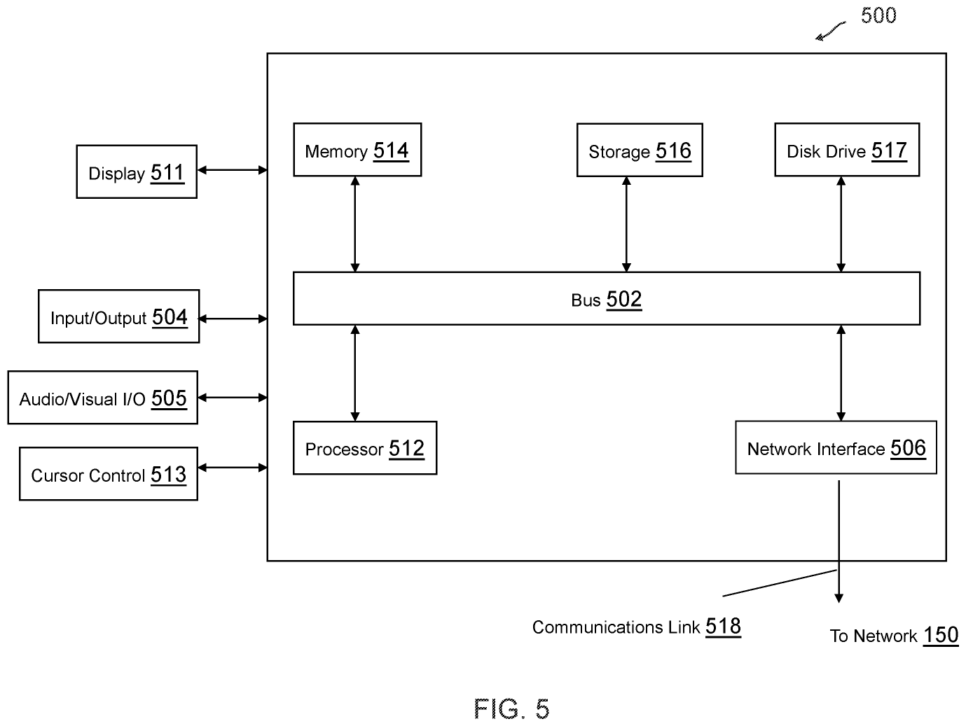

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
determining, using a machine learning (ML) model for a prediction associated with a user, a model output score based on feature data for a subset of model features utilized by the ML model for the prediction, wherein the feature data for the subset of the model features includes corresponding missing data for at least one of the model features;
computing a decay score associated with the model output score based on the ML model and the at least one of the model features;
identifying a token available via an Internet of Things (IoT) infrastructure that is associated with the feature data, wherein the token enables a model accuracy of the ML model for the model output score to be adjusted; and
generating an enriched model score token for the model output score based in part on the token and the decay score.

2. The service provider system of claim 1, wherein the enriched model score token comprises a secure fraud token for a fraud assessment engine having at least one of an increased time-to-live (TTL) or an increased model accuracy rating based on token data associated with the token.

3. The service provider system of claim 1, wherein the operations further comprise:
processing a transaction using the enriched model score token for a fraud score determination using a fraud detection model, wherein the fraud score determination is used for approving or declining the transaction.

4. The service provider system of claim 3, wherein the processing the transaction comprises performing a corrective operation for the fraud score determination using the enriched model score token in place of the model output score.

5. The service provider system of claim 1, wherein the operations further comprise:
computing, based on the corresponding missing data for the at least one of the model features, an entropy score of the model output score based on the at least one of the model features having the corresponding missing data for the model output score and a past model output score for the user,
wherein the enriched model score token is further generated using the entropy score.

6. The service provider system of claim 5, wherein the computing the entropy score comprises:
retrying, using an entropy function, an application programming interface (API) call to an API that failed when attempting to retrieve the corresponding missing data; and
assessing, using the entropy function, a data randomness introduced to an accuracy of the model output score based on determining the model output score with and without the corresponding missing data.

7. The service provider system of claim 1, wherein the computing the decay score comprises:
executing a fraud decay manager comprising a decay function based on a plurality of decay parameters associated with initial feature values and decay constants; and
calculating, based on a result of the executing, the decay score based on the feature data.

8. The service provider system of claim 7, wherein the decay score is computed as a function of a dataset for the model features, a transaction history for the user, and a financial instrument used by the user in association with the prediction.

9. The service provider system of claim 1, wherein a TTL value of the enriched model score token decreases proportionally based on a number of the model features having unavailable data to the ML model and the decay score.

10. The service provider system of claim 1, wherein the ML model is invoked, and the model output score determined, in response to a payment request routed to a fraud protection system of the service provider system, and wherein the model output score comprises a fraud score used to approve or decline the payment request, and wherein the token is associated with real-time data captured at a location associated with the payment request using the IoT infrastructure.

11. The service provider system of claim 1, wherein the corresponding missing data is associated with an API failure, an unresponsive API call, or a failed API data call for the corresponding missing data.

12. The service provider system of claim 1, wherein the token is associated with tokenized data that enables a real-time data detection using the IoT infrastructure for a location, and wherein the IoT infrastructure comprises a plurality of sensors at the location that monitors at least the real-time data detection for the token.

13. The service provider system of claim 12, wherein the token comprises a secure cryptogram generated using the real-time data detection with one or more of the plurality of sensors and comprises a TTL.

14. A method comprising:
receiving a machine learning (ML) model score for a prediction made using an ML model and feature data for model features of the ML model and an identification of missing feature data for one of the model features based on an application programming interface (API) failure to retrieve the missing feature data of the one of the model features;
determining a decay score for the ML model score based on the one of the model features having the missing feature data and the ML model, wherein the decay score indicates an accuracy change of the ML model score over time since the prediction;
obtaining a digital token for real-time Internet of Things (IoT) data from an IoT infrastructure for at least a portion of the model features, wherein the digital token is obtained to increase an accuracy of the ML model based on the real-time IoT data;
generating an enriched model score token for the ML model score based in part on the decay score and the digital token;
determining an increase in the accuracy and a time-to-live (TTL) of the ML model score based on the ML model and the enriched model score token; and
updating the ML model score with the increase in the accuracy and the TTL.

15. The method of claim 14, wherein the increase in the TTL increases a time period of validity for the ML model score with a fraud detection system.

16. The method of claim 14, wherein, prior to the increase in the accuracy and the TTL, the TTL of the ML model score is decreased proportionally to an amount of data missing in the missing feature data for the ML model.

17. The method of claim 14, wherein the ML model score is associated with a processing of an electronic transaction with an online transaction processor, and wherein the ML model score is used to approve or decline the electronic transaction during the processing.

18. The method of claim 14, wherein the digital token comprises a secure cryptogram for the real-time IoT data detected using one or more real-world sensors for the IoT infrastructure.

19. A non-transitory machine-readable medium having stored thereon machine-readable instructions executable to cause a machine to perform operations comprising:
determining a machine learning (ML) model score using an ML model and feature data associated with model features of the ML model;
computing a decay score using a decay function associated with a time-based decay of one or more of the model features and the ML model score;
retrieving a data token from a real-time data infrastructure for the one or more of the model features, wherein the data token allows an accuracy of the ML model score to be adjusted based on real-time data for the one or more of the model features; and
generating an enriched model score token for the ML model score based in part on the decay score and the data token, wherein the enriched model score token includes the accuracy of the ML model score adjusted based on the real-time data.

20. The non-transitory machine-readable medium of claim 19, wherein the feature data is missing individual feature data for the one or more of the model features based on an application programming interface (API) failure, and wherein the data token is retrieved for the real-time data associated with the individual feature data based on the API failure.
